(19) United States
(12) Patent Application Publication
(10) Pub. No.: US 2005/0050844 A1
(43) Pub. Date: Mar. 10, 2005

(54) Set of building components for building structures and methods for utilizing such a set of building components

(76) Inventor: Daniel G. Styles, South Pasadena, CA (US)

Correspondence Address: Eric K. Satermo;Registered Patent Agent, P.O. Box 19099, Irvine, CA, 92623-9099, US

(21) Appl. No.: 10/858,563

(22) Filed: Jun. 1, 2004

Related U.S. Application Data
(60) Provisional application No. 60/474,414, filed on May 30, 2003.

(51) Int. Cl. C08G 18/00

(52) U.S. Cl. 52/750

(57) ABSTRACT

A set of building components for building structures includes a plurality of building components that are configured to enable a plurality of structures to be built. The physical characteristics of the building components enable the building components to be held together in the form of a structures, such as a multi-pointed star, through frictional forces only and without the need for external fastening means such as adhesive, nails, tape, and so on. A building component may have a pair of sides each including a surface with an untreated coefficient of friction. At least one of the sides of the building component includes a treated portion that has a treated coefficient of friction that is different than the untreated coefficient of friction. The treated coefficient of friction may be greater than the untreated coefficient of friction. A building component may be defined by a length and a thickness. The length and the thickness of the building component may be selected to enable the building component to bend through a predetermined angle, for example, at least about 20 degrees.

### CROSS REFERENCE TO RELATED APPLICATIONS

The present invention claims priority on U.S. Provisional Application for Patent Ser. No. 60/474,414 filed May 30, 2003, the entire application of which is incorporated herein by reference.

### BACKGROUND OF THE INVENTION

The invention relates to building components for building structures. The invention also relates to methods and apparatus associated with building systems; architectural projects sets; children's learning and educational toys and books; puzzles and games; as well as creative design programs, educational classes, and arts and crafts projects. Applications include book sets, games and teaching programs/classes and the like, for children and adults in a variety of commercial and educational products serving a variety of end users and market segments.

There is no existing prior art of this form and substance. The component building components or other similar material (craft building components and supplies) although readily available for craft projects have not been developed into such a program/system of building whereby structures are built, based on principles of math, physics and basic architecture, without the help of any form of adhesive.

### SUMMARY OF THE INVENTION

According to one of the embodiments, a set of building components for building structures includes a plurality of building components that are configured to enable a plurality of structures to be built. The physical characteristics of the building components enable the building components to be held together in the form of a structure, such as a multi-pointed star, through frictional forces only and without the need for external fastening means such as adhesive, nails, tape, and so on.

In a number of embodiments, a building component may have a pair of sides each including a surface with an untreated coefficient of friction. At least one of the sides of the building component includes a treated portion that has a treated coefficient of friction that is different than the untreated coefficient of friction. In some of the embodiments, the treated coefficient of friction is greater than the untreated coefficient of friction.

In other embodiments, a building component may be defined by a length and a thickness. The length and the thickness of the building component may be selected to enable the building component to bend through a predetermined angle, for example, at least about 20 degrees.

Other objects and features of the invention will become apparent to those having skill in the art from the following detailed description and referenced drawings.

### BRIEF DESCRIPTION OF THE SEVERAL VIEWS OF THE DRAWINGS

FIG. 1 is a perspective view of a set of building components for building structures according to a number of embodiments;

FIGS. 2A to 2D illustrate methodology for building a structure with a set of building components;

FIG. 3 is a plan view of a side of a building component according to a number of embodiments;

FIG. 4 is a side view of the building component of FIG. 3;

FIG. 5 illustrates physical properties such as flexibility of a building component in some of the embodiments;

FIG. 6 is a plan view of a side of a building component according to other embodiments;

FIG. 7 is a side view of the building component of FIG. 6;

FIG. 8 is a fragmentary perspective view of a building component according to one of the embodiments;

FIG. 9 is a perspective view of a building component according to other embodiments;

FIG. 10 is a fragmentary perspective view of a building component according to still other embodiments;

FIG. 11 is a fragmentary perspective view of a building component according to further embodiments;

FIG. 12 is a perspective view of a component according to other embodiments;

FIG. 13 is a cross-sectional view of an embodiment of a building component with a substantially uniform composition and a rectilinear cross section;

FIG. 13A is a fragmentary view of a component of another embodiment;

FIG. 14 is a cross-sectional view of another embodiment of a building component coated with a material;

FIG. 15 is a cross-sectional view of still another embodiment of a building component with sides coated with a material;

FIG. 16 is a cross-sectional view of yet another embodiment of a building component with a triangular cross section;

FIG. 17 is a cross-sectional view of a still another embodiment of a building component with a curvilinear cross section;

FIG. 18 is an enlarged fragmentary view illustrating overlapping of building components;

FIG. 19 is an enlarged fragmentary view illustrating interweaving of building components;

FIG. 20 illustrates a building component according to other embodiments;

FIG. 21 illustrates a building component according to still other embodiments;

FIG. 22 illustrates a building component according to yet other embodiments;

FIG. 23 illustrates a building component according to further embodiments;

FIG. 24 illustrates a building component according to still further embodiments;

FIG. 25 illustrates a building component according to yet further embodiments;

FIG. 26 illustrates a building component according to other embodiments;

FIG. 27 illustrates a building component according to still other embodiments; and

FIG. 28 illustrates a building component according to yet another embodiment.

### DETAILED DESCRIPTION OF THE INVENTION

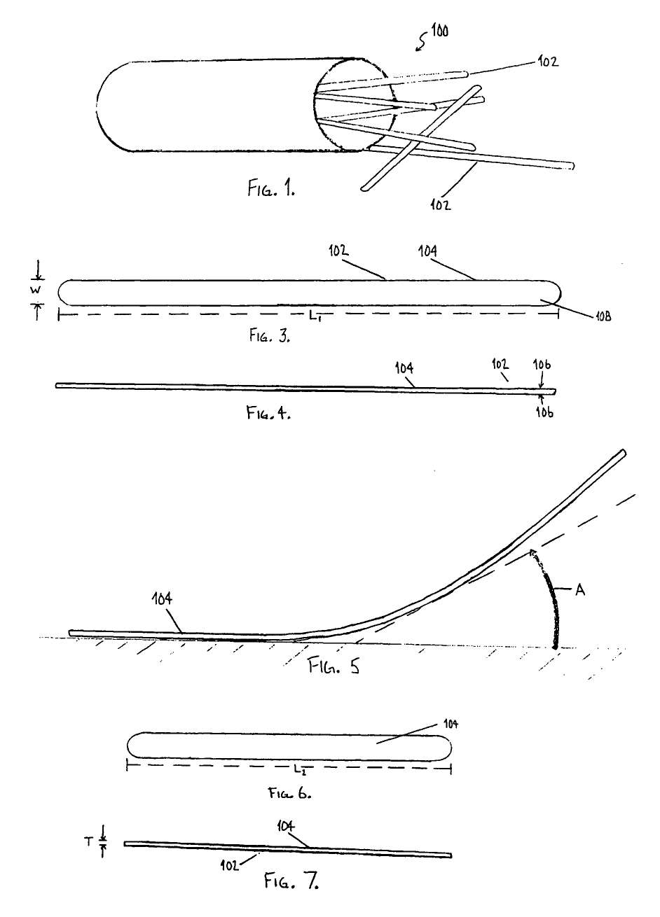

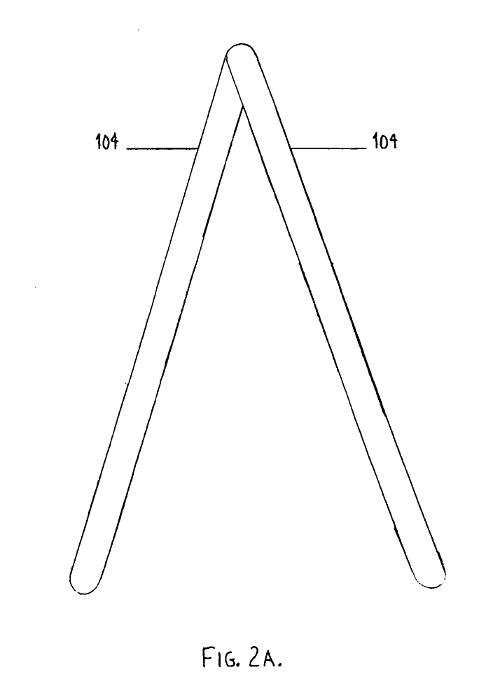

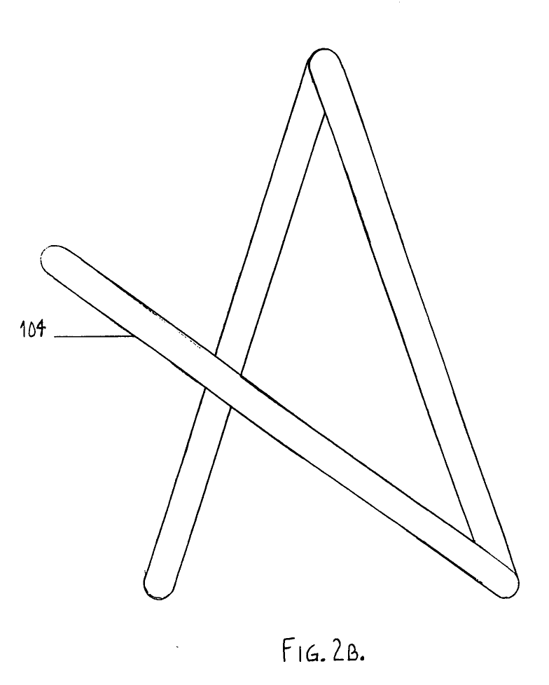

Referring to the drawings in more detail, a set 100 of building components for building structures is illustrated in FIG. 1. The set 100 includes a plurality of building components 104 that are configured to enable structures to be constructed. An example of one such structure is illustrated in FIGS. 2A to 2D, which will be discussed in more detail below.

With additional reference to FIGS. 3 and 4, each of the building components 104 may have a pair of sides 106. In a number of embodiments, the building component 104 may be defined as having a length L, a width W, and a thickness T, with the respective dimensions being selected to enable substantial flexibility of the building component 104. More particularly, as shown in FIG. 5, the length L and the thickness T may be selected to enable the building component 104 to bend through a predetermined angle A. In some of the embodiments, the angle A may be at least about 30 degrees. In other embodiments, the angle A may be at least about 20 degrees. In still other embodiments, the angle A may be at least about 60 degrees. More generally, the building component 104 has sufficient flexibility and resiliency to enable a plurality of the building components to be interwoven together to form a structure, which is discussed in more detail below. Accordingly, the components 104 may be configured with any flexibility that enables bending through any desired angle A that enables interweaving of a plurality of components 104 into a structure.

In a number of embodiments, the dimensions of the building component 104 may be selected such that the length L is about 7 inches and the thickness T is about 1/16 inch. In other embodiments, such as shown in FIGS. 6 and 7, the length L may be about 4 inches, and the thickness T may be about 1/16 inch. In other embodiments, the thickness T may range from about 1/20 inch to about 1/10 inch. Regardless of these examples of specific embodiments, the building component 104 may be manufactured with dimensions based on the physical properties of the building component (e.g., if the building component is made out of a particular wood or from plastic) that results in a desired flexibility.

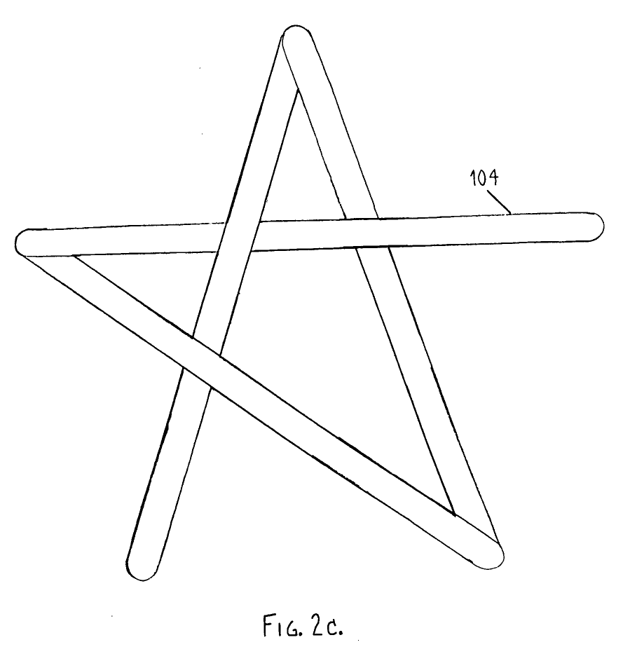

In other embodiments, such as shown in FIGS. 8 and 9, each of the sides 106 may include a surface 108 with an untreated portion 110 with an untreated coefficient of friction μ_{S1}. In some of the embodiments, at least one of the sides 106 of the building component 104 may include a treated portion 112 with a treated coefficient of friction μ_{S2} that is different than the untreated coefficient of friction μ_{S1}. In a number of embodiments, the treated coefficient of friction μ_{S2} is greater than the untreated coefficient of friction μ_{S1} which may facilitate the building of structures with the building components 104.

As shown in FIG. 10, an extent P of the treated portion 112 may vary in size on the building component 104. For example, the extent P of the treated portion 112 may be about ¼ inch, ½ inch, 1 inch, and so on. In other embodiments, the extent P may be substantially equal to the length L of the component 104, thereby rendering a component 104 with a single coefficient of friction.

In still other embodiments as shown in FIG. 11, the building component 104 may include a plurality of untreated portions 110 and a plurality of treated portions 112. As shown in FIG. 9, the treated portions 112 may be disposed at opposing ends of the building component 104. In further embodiments as shown in FIG. 12, the building component 104 may include a second treated portion 114 that has a coefficient of friction μ_{S3} that is different from those of the untreated portion 110 and the first treated portion 112.

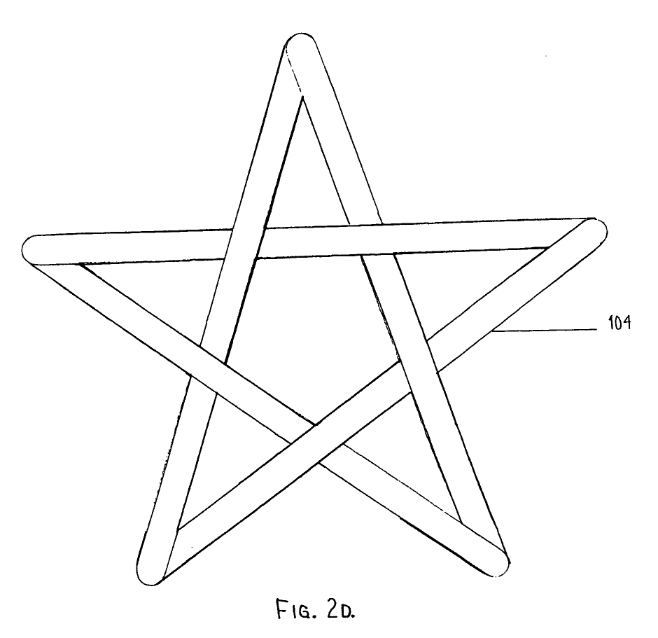

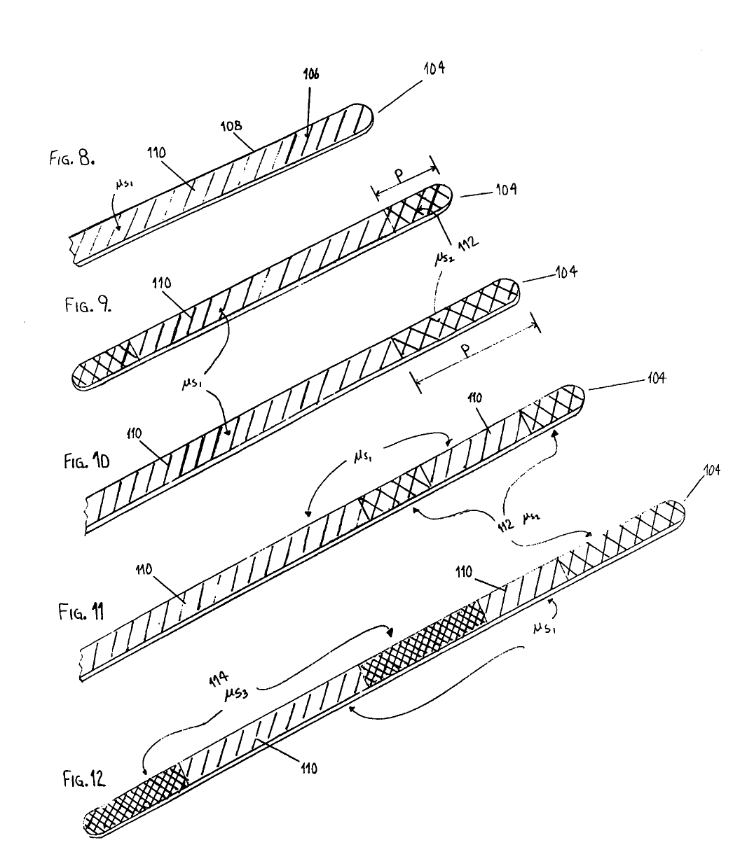

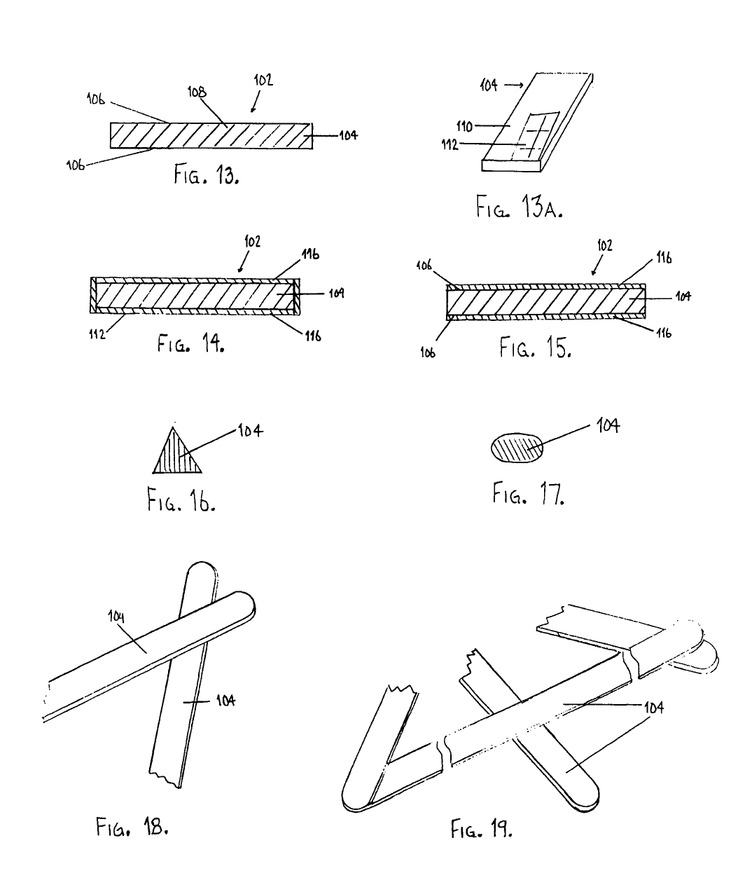

In a number of embodiments, such as shown in FIG. 13, the building component 104 may be made uniformly from a material such as wood or plastic. In wood embodiments, the untreated portion 110 may be defined as the surface 108 of the sides 106 with a smooth cut, and the treated portion 112 may include a portion of the surface 108 that is, for example, physically roughened or chemically treated. For example, as shown in FIG. 13A, the treated portion 112 may include a roughened surface. Alternatively, as shown in FIG. 14, the treated portion 112 may include a layer of material 116 such as paint applied to the building component 104. The layer of material 116 may be applied to or coated on the building component 104 on all sides as shown in FIG. 14 or, alternatively, only to one or more of the surfaces 108 as shown in FIG. 15. In embodiments in which the layer of material 116 is applied to at least both of the surfaces 108, the treated portion 112 and the treated coefficient of friction encompasses the entire extent of the surfaces 108, thereby rendering a component 104 with a single coefficient of friction on the surfaces 108.

In embodiments in which the component 104 is made out of plastic, the treated portion 112 may be formed by having a desired pattern or structure on a mold which imparts a desired texture or roughness to a surface 108 of the component 104, thereby rendering a treated portion 112 and a desired coefficient of friction. In other embodiments, the components 104 may be made out of any material or combination of materials that enable interweaving of components into structures.

As shown in FIG. 13, the building component 104 may have a substantially uniform cross section, for example, a rectilinear cross section. In other embodiments such as shown in FIG. 16, the building component 104 may have a triangular cross section (in which embodiment the building component 104 includes a plurality of or three sides 106 and surfaces 108). In further embodiments as illustrated in FIG. 17, the building component 104 may have a curvilinear cross section such oval or circular. More generally, the building component 104 may be configured with any type of cross section that enables the building components 104 to be interwoven into structures, as discussed below.

With reference to FIGS. 2A to 2D, a plurality of the building components 104 may be connected together to build a structure. For the purposes of this description, the structure is a five-pointed star. For example, as shown in FIG. 2A, two building components 104 may be positioned across or overlapped with one end on top of the other. The overlapping of the ends of the components 104 is shown in detail in FIG. 18. A third building component 104 may be positioned across or overlapped with the other two as shown in FIG. 2B. A fourth building component 104 may then be interwoven with the first two building components as shown in FIG. 2C. The interweaving of the components 104 is shown in detail in FIG. 19. A fifth building component 104 may then be interwoven with the assembly as shown in FIG. 2D to complete the structure.

In embodiments with treated portions 112 having greater coefficients of friction, the interweaving of the building components 104 is facilitated by the greater forces required to overcome the greater frictional forces, thereby “holding” the building components 104 together without external fastening means such as adhesive. The building components 104 may then be dismantled to build another structure. In embodiments with either a single coefficient of friction or multiple coefficients of friction, the interweaving and overlapping of components 104 causes the components to exert forces upon one another through resiliency and flexibility, thereby creating tension and holding the components 104 together without external fastening means such as adhesives.

The dismantling and interweaving of the building components 104 may be repeated any number of times to build a variety of structures because external fastening means such as adhesive is not required to hold the building components 104 together in the form of a structure. Rather, the frictional forces of the interwoven building components 104 hold the building components together in the shape of the desired structure. Accordingly, a plurality of the building components 104 may be interwoven to complete a structure. Although a five-pointed star is provided as an example, any number of structures may be completed, a number of which are disclosed in Provisional Application for Patent Ser. No. 60/474,414, from which this application claims priority and which application is incorporated by reference. The structures may be substantially two-dimensional as shown or may be three-dimensional.

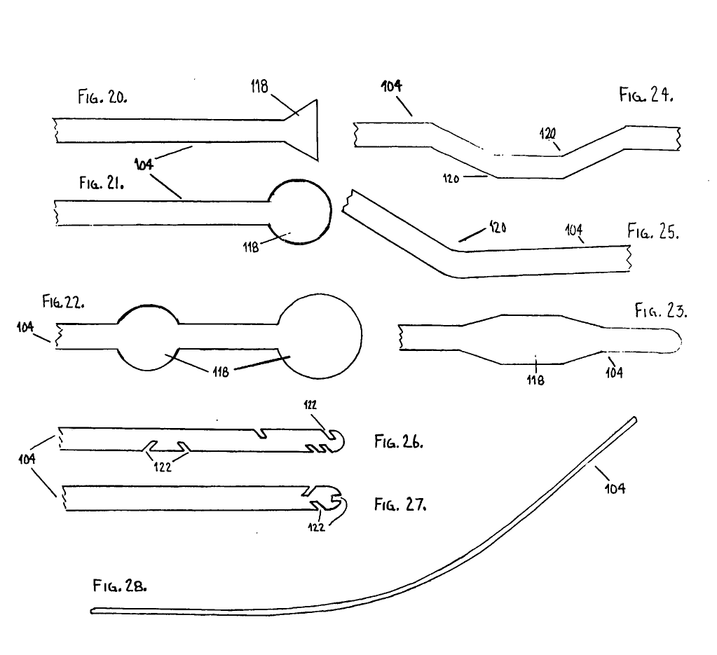

In addition to the examples described above, the building component 104 may be configured in any number of embodiments. For example, as shown in FIG. 20, a building component 102 may include an enlarged portion 118 positioned at, e.g., an end of the component for facilitating the engagement of two or more components 104. The enlarged portion 118 may be rectilinear as shown in FIG. 20 or, alternatively, curvilinear as shown in FIG. 21. In other embodiments, the component 104 may include a plurality of enlarged portions 118 as shown in FIG. 22. The enlarged portion 118 may positioned at a distance away from an end of the component 104 as shown in FIG. 23.

In further embodiments, the component 104 may include one or more discontinuities, kinks, or bends 120 as shown in FIGS. 24 and 25 for facilitating engagement of components. In other embodiments, the component 104 may include one or more grooves or notches 122 disposed at locations along the component 104 as shown in FIG. 26 or at or near an end of the component 104 as shown in FIG. 27, with the notches 122 facilitating engagement of components 104 without the use of external fastening means.

Those skilled in the art will appreciate that the present invention may be embodied in other specific forms without departing from the spirit or central attributes thereof. For example, the building components 104 may be made from any material that enables sufficient flexibility to be interwoven, and the building components 104 may be any color, size, and shape. In addition, the building component 104 may be curved or warped in an unstressed position as shown in FIG. 28. Further, the set 100 may include stickers for application to the components 104 to enable a user to decorate or customize the look of the components. Accordingly, in that the foregoing description of the present invention discloses only an exemplary embodiment, it is to be understood that other variations are contemplated as being within the scope of the present invention. Accordingly, the present invention is not limited to the particular embodiments which have been described in detail herein but rather by the scope of the following claims.

1. A set of building components for building structures, each of the building components comprising:
a pair of sides each including a surface with an untreated coefficient of friction;
wherein at least one of the sides of the building component includes a treated portion that has a treated coefficient of friction that is different than the untreated coefficient of friction.

2. The set of building components of claim 1 wherein the treated coefficient of friction is greater than the untreated coefficient of friction.

3. The set of building components of claim 1 wherein the treated portion of at least one of the building components includes the surface of at least one of the sides of the building component.

4. The set of building components of claim 1 wherein the treated portion of at least one of the building components includes the surface of both sides of the building component.

5. The set of building components of claim 1 wherein the treated portion of at least one of the building components includes a roughened surface.

6. The set of building components of claim 1 wherein the treated portion of at least one of the building components includes a painted surface.

7. The set of building components of claim 1 wherein at least one of the building components includes a plurality of treated portions each having a coefficient of friction that is different than the untreated coefficient of friction.

8. The set of building components of claim 1 wherein at least one of the building components includes a pair of the treated portions disposed at or near opposing ends of the building component.

9. The set of building components of claim 1 wherein each of the sides of at least one of the building components includes a treated portion.

10. The set of building components of claim 1 wherein at least one of the building components has a substantially uniform cross section.

11. The set of building components of claim 1 wherein at least one of the building components has a rectilinear cross section.

12. The set of building components of claim 1 wherein at least one of the building components has a curvilinear cross section.

13. The set of building components of claim 1 wherein at least one of the building components has a rectangular cross section.

14. The set of building components of claim 1 wherein at least one of the building components is coated with a material that has a different coefficient of friction than the uncoated coefficient of friction.

15. The set of building components of claim 1 wherein at least one of the building components is defined by a length and a thickness, the length and the thickness being selected to enable the building component to bend through an angle of at least about 20 degrees.

16. A set of building components for building structures, each of the building components being defined by a length and a thickness, the length and the thickness being selected to enable the building component to bend through an angle of at least about 20 degrees, wherein a plurality of the building components can be interwoven to build a structure.

17. The set of building components of claim 16 wherein at least one of the building components has a pair of sides each including a surface with an untreated coefficient of friction, wherein at least one of the sides of the building component includes a treated portion that has a treated coefficient of friction that is different than the untreated coefficient of friction.

18. The set of building components of claim 17 wherein the treated coefficient of friction is greater than the untreated coefficient of friction.

19. A method of building a structure, the method comprising:
a) providing a set of building components each having a pair of sides, each of the sides including a surface with an untreated coefficient of friction, at least one of the sides of the building component having a treated portion that has a treated coefficient of friction that is different than the untreated coefficient of friction; and
b) interweaving a plurality of the building components into a structure.

20. The method of claim 19 wherein the set of building components includes at least one building component defined by a length and a thickness, the length and the thickness being selected to enable the building component to bend through an angle of at least about 20 degrees.

21. The method of claim 19 further comprising the steps of:
c) dismantling the building components; and
d) interweaving a plurality of building components into another structure.

22. The method of claim 21 further comprising the step of:
e) repeating steps (c) and (d) a plurality of times.

23. A method of building a structure, the method comprising:
a) providing a set of building components each being defined by a length and a thickness, the length and the thickness being selected to enable the building component to bend through an angle of at least about 20 degrees, wherein a plurality of the building components can be interwoven to build a structure.
b) interweaving a plurality of the building components into a structure.

24. The method of claim 19 wherein the set of building components includes at least one building component that has a pair of sides each including a surface with an untreated coefficient of friction, wherein at least one of the sides of the building component includes a treated portion that has a treated coefficient of friction that is different than the untreated coefficient of friction.

25. The method of claim 19 further comprising the steps of:
c) dismantling the building components; and
d) interweaving a plurality of building components into another structure.

26. The method of claim 21 further comprising the step of:
e) repeating steps (c) and (d) a plurality of times.
